(19) United States
(12) Patent Application Publication
(10) Pub. No.: US 2012/0110994 A1
(43) Pub. Date: May 10, 2012

(54) Sealed Master Cylinder and Plunger of Vehicle Hydraulic-Brake System

(76) Inventor: Der-San Chen, Tainan County (TW)

(21) Appl. No.: 13/108,015

(22) Filed: May 16, 2011

(30) Foreign Application Priority Data
Nov. 5, 2010 (TW) 099138126

(51) Int. Cl. B60T 17/00; F16J 15/32

(52) U.S. Cl. 60/533; 277/549

(57) ABSTRACT

A sealed master cylinder and plunger of a vehicle hydraulic-brake system, includes a master cylinder, a plunger and a seal collar. The master cylinder is adjacent the plunger and has a holding slot disposed thereon and adjacent the plunger, and the seal collar provided in the holding slot. The seal collar comprises a collar body, separated into a circumferential inner wall and a circumferential outer wall, both of which are pliable. The sealed master cylinder and plunger further comprises a first fluid passage formed between the circumferential inner wall and the plunger and a second fluid passage formed between the circumferential outer wall and the holding slot.

### BACKGROUND OF THE PRESENT INVENTION

1. Field of Invention

The present invention relates to a sealed master cylinder and plunger, and more particularly to a sealed master cylinder and plunger of a vehicle hydraulic-brake system.

2. Description of Related Arts

A typical sealed master cylinder and plunger of a vehicle hydraulic-brake system generally comprises a master cylinder, a plunger, and a seal collar—wherein the master cylinder further comprises a holding slot for holding the seal collar such that the holding slot is adjacent the plunger. The seal collar is material-designed, shaped, and tightly installed to block the passage of the fluid around the plunger. However, when the plunger moves forth-and-back, the seal collar is deformed to generate a fluid passage for permitting a fluid—generating a pressure or relieving a pressure according to the space change—to pass through to form a reflowing pressure relief fluid.

Referring to FIG. 9, in U.S. Pat. No. 7,181,911, a seal collar 41 is illustrated. The seal collar 41 is installed between a master cylinder 42 and a plunger 43 to seal them. Preferably, the master cylinder 42 comprises a containing groove disposed adjacent the master cylinder 42 and the plunger 43, and the seal collar 41 is in the containing groove. The seal collar 41 is material-designed, shaped and tightly installed to block the passage of the fluid around the plunger 43. However, when the plunger 43 moves forth-and-back, the seal collar 41 is deformed to generate a fluid passage for permitting a pressure relief fluid to pass through to form a reflowing fluid; the flowing of the fluid is formed due to the forth-and-back movement of the plunger 43. When the plunger 43 moves in the same direction of the open direction of the seal collar 41 the opening of the seal collar 41 is expanded outward by the plunger 43 to block the flowing of the fluid, so fluid pressure is generated. When the plunger 43 moves in the opposite direction of the open direction of the seal collar 41, the fluid is permitted to flow along a clearance 46—between the plunger 43 and the master cylinder 42—and then to flow back to the forth-and-back space 47 of the plunger 43 to form a pressure relief fluid. Referring to FIG. 9, the seal collar 41 comprises a collar body 410, wherein the inner side and the outer side of the collar body 410 are in the same axis, and the top side and the bottom side in the same radial direction of the collar body 410. The collar body 410 comprises a first circle wall 411 and a second circle wall 412 disposed on the inner side of the collar body 410. Referring to FIG. 9, the first circle wall 411 is adjacent the side wall 441 of the holding slot 44. As the first circle wall 411 is tightly attached to the side wall 441, no reflowing fluid passage could be formed. Hence, the pressure relief fluid could only flow along the clearance 46 between the plunger 43 and the master cylinder 42, and then deform the second circle wall 412 to flow back to the forth-and-back space 47 of the plunger 43. The seal collar 41 resists against the forming of the reflowing fluid passage.

Referring to FIG. 10, in the U.S. Pat. No. 7,401,468, a seal collar 51 is illustrated. It also comprises a first circle wall 511, a second circle wall 512, and a protruding circle wall 513 disposed between the first and the second circle walls. The first circle wall 511 is adjacent side wall 541 of a containing groove 54 and has a little arc to reduce the contact area and resistance, and a reflowing fluid passage might be formed. However, as the second circle wall 512 is tightly attached to the plunger surface 531 of the plunger 53, no reflowing fluid passage can be formed. Hence, the reflowing pressure relief fluid could only flow along the clearance 56 between the first circle wall 511 and the side wall 541 of the containing groove 54, and then deform the first circle wall 511 to flow back to the forth-and-back space 55 of the plunger 53 under a lot of resistance.

Referring to FIG. 11, in the U.S. Pat. No. 7,600,761, a seal collar 61 is illustrated, which also comprises a first circle wall 611 and a second circle wall 612, and a protruding circle wall 613 between the first and the second circle walls.

As the first circle wall 611 is adjacent the side wall 641 of a containing groove 64 and the second circle wall 612 is tightly attached to the plunger surface 631 of the plunger 63, no reflowing fluid passage can be formed. Hence, the reflowing pressure relief fluid only flows along the clearance 66 between the first circle wall 611 and the side wall 641 of the containing groove 64, and then deforms the first circle wall 611 to flow back to the forth-and-back space of the plunger 63 under a lot of resistance.

### SUMMARY OF THE PRESENT INVENTION

The invention is advantageous in that it provides a sealed master cylinder and plunger of a vehicle hydraulic-brake system to overcome the shortcomings in the prior art.

Additional advantages and features of the invention will become apparent from the description which follows, and may be realized by means of the instrumentalities and combinations particular point out in the appended claims.

According to the present invention, a sealed master cylinder and plunger comprises a master cylinder, a plunger and a seal collar. The master cylinder is adjacent the plunger and has a holding slot disposed thereon and adjacent the plunger, and the seal collar is provided in the holding slot. The seal collar comprises a collar body, separated into circumferential inner outer walls. The circumferential inner wall comprises a plurality of distanced gaps disposed thereon, and the circumferential inner wall and the circumferential outer wall respectively has an expansive configuration expanded outward from a base end to a free end, whereby the thickness and pitch of the circumferential inner wall and the circumferential outer wall is respectively gradually changed, so the circumferential inner wall and the circumferential outer wall are pliable.

The sealed master cylinder and plunger comprises two fluid passages. The circumferential inner wall comprises a plurality of distanced gaps disposed thereon, which weakens the circumferential strength thereof, so the circumferential inner wall is pliable. Hence, when the fluid flows along the interface between the inner side of the seal collar and the plunger, it can easily overcome the resistance of the circumferential inner wall to form a first reflowing fluid passage—without influencing the sealing effect. Meanwhile, the external diameter of the collar body expands outwards, so the thickness and pitch of the circumferential outer wall is gradually changed so the circumferential outer wall is pliable. Hence, when the fluid flows along the interface between the outer side of the seal collar and the holding slot, the fluid can easily overcome the pressure relief resistance of the circumferential outer wall to reflow through a clearance to form a second reflowing fluid passage. Hence, the reflowing fluid flows along the two formed fluid passages at the same time to flow through the seal collar, and then flows to the forth-and-back space of the plunger, wherein the resistance formed by pressure relief of the hydraulic cylinder and provided to the reflowing fluid is greatly reduced.

These and other objectives, features, and advantages of the present invention will become apparent from the following detailed description, the accompanying drawings, and the appended claims.

### BRIEF DESCRIPTION OF THE DRAWINGS

FIG. 1 is a plan view of a sealed master cylinder and plunger according to a first preferred embodiment of the present invention.

FIG. 2 is a partial enlarged view of FIG. 1.

FIG. 3 illustrates the actuating of the sealed master cylinder and plunger of FIG. 1.

FIG. 4 is a plan view of a seal collar according to the first preferred embodiment of the present invention.

FIG. 5 illustrates a holding slot of a plunger according to another preferred embodiment of the present invention.

FIG. 6 is a perspective view of the seal collar according to the first preferred embodiment of the present invention.

FIG. 7 is a perspective view of the seal collar according to a second preferred embodiment of the present invention.

FIG. 8 is a perspective view of the seal collar according to a third preferred embodiment of the present invention.

FIG. 9 is a representative view of a holding slot of a seal collar according to a first embodiment in the prior art.

FIG. 10 is a representative view of a holding slot of a seal collar according to a second embodiment in the prior art.

### DETAILED DESCRIPTION OF THE PREFERRED EMBODIMENT

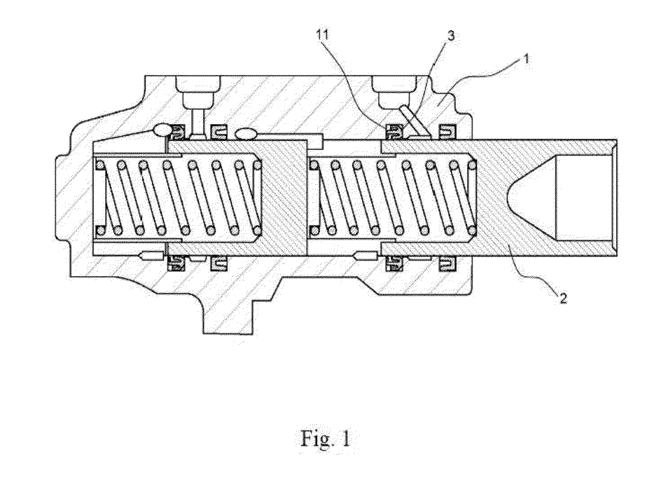

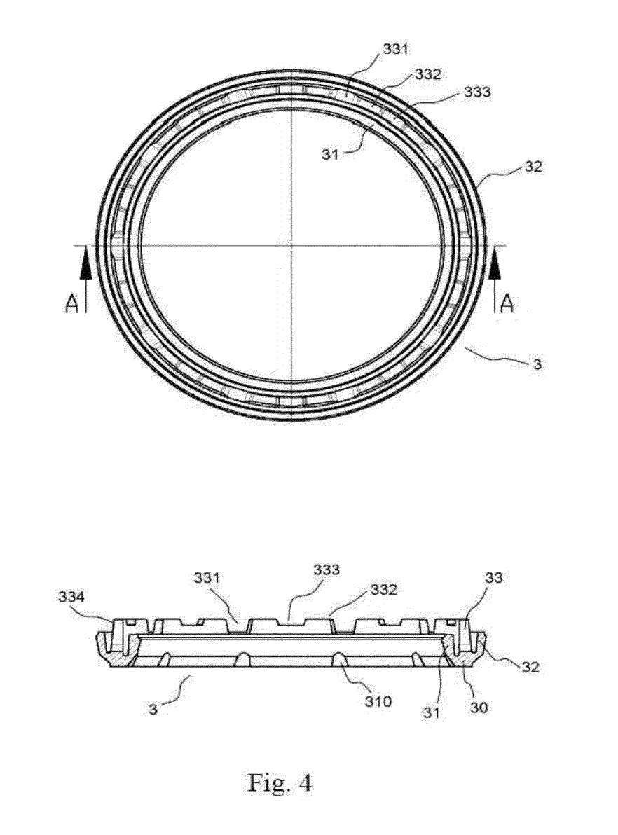

Referring to FIGS. 1-3, a sealed master cylinder and plunger of vehicle hydraulic-brake system of the present invention comprises a master cylinder 1, a plunger 2 and a seal collar 3. The master cylinder 1 is adjacent the plunger 2 with a holding slot 11 disposed thereon and adjacent the plunger 2, and the seal collar 3 is provided and held in the holding slot 11. The seal collar 3 is material-designed, shaped and tightly installed to be deformable that the seal collar 3 block the passage of the fluid around the plunger 2 and is deformed by the forth-and-back movement of the plunger 2 to generate two fluid passages, for permitting a pressure relief fluid, such as a brake fluid, to pass through. The deformation of the seal collar 3 is illustrated in FIG. 3. The plunger 2 moves forth and back in a forth-and-back space 7. The plunger 2 moves along with the holding slot 11 outside the seal collar 3 to communicate with the forth-and-back space 7 with a first clearance D1, so the fluid flows through the seal collar 3 and then along a second clearance D2 between the plunger 2 and the master cylinder 1 to reflow to the forth-and-back space 7 of the plunger 2.

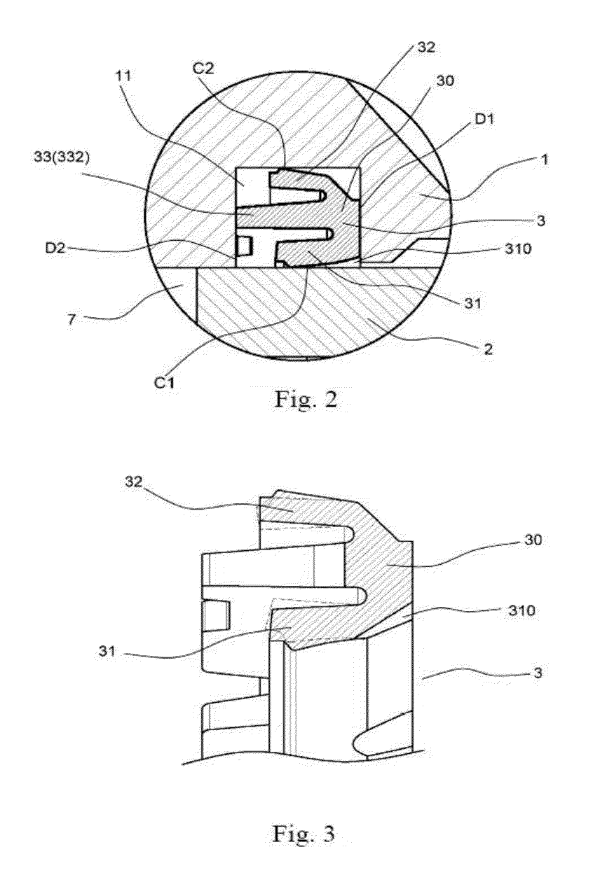

Referring to FIGS. 4-5 and FIG. 2, the seal collar 3 of the present invention is illustrated, wherein the seal collar 3 comprises a collar body 30 separated into a circumferential inner wall 31 and a circumferential outer wall 32. The circumferential inner wall 31 comprises a plurality of distanced gaps 310 disposed thereon, which weakens the circumferential strength thereof, so the circumferential inner wall 31 is pliable. Hence, when the fluid flows along the interface between the inner side of the seal collar 3 and the plunger 2, the fluid can easily overcome the resistance of the circumferential inner wall 31 to form a first reflowing fluid passage C1 without influencing the sealing effect. Meanwhile, the external diameter of the collar body 30 expands outwards, so the thickness and pitch of the circumferential outer wall 32 is gradually changed so the circumferential outer wall 32 is pliable. Hence, when the fluid flows along the interface between the outer side of the seal collar 3 and the holding slot 11, the fluid can easily overcome the pressure relief resistance of the circumferential outer wall 32 to reflow through the first clearance D1 to form a second reflowing fluid passage C2. The fluid flows along the second clearance D2 between the plunger 2 and the master cylinder 1 and then to the forth-and-back space 7 of the plunger 2. Hence, the reflowing fluid flows along the two formed fluid passages at the same time to flow through the seal collar 3, and then flows to the forth-and-back space 7 of the plunger 2, so the resistance formed by pressure relief of the hydraulic cylinder and provided to the reflowing fluid is greatly reduced.

The circumferential inner wall 31 and the circumferential outer wall 32 respectively has an expansive configuration expanded outward from the base end to the free end as illustrated in FIG. 2, so the thickness and pitch of the circumferential inner wall 31 and the circumferential outer wall 32 is respectively gradually changed so as to result that the circumferential inner wall 31 and the circumferential outer wall 32 is pliable. Hence, when the fluid flows along the clearance D1, the fluid can easily overcome the resistance of the circumferential outer wall 32 to pass through the seal collar 3. Meanwhile, the fluid can flows along the clearance D2 between the plunger 2 and the master cylinder 1 and then to the forth-and-back space 7 of the plunger 2.

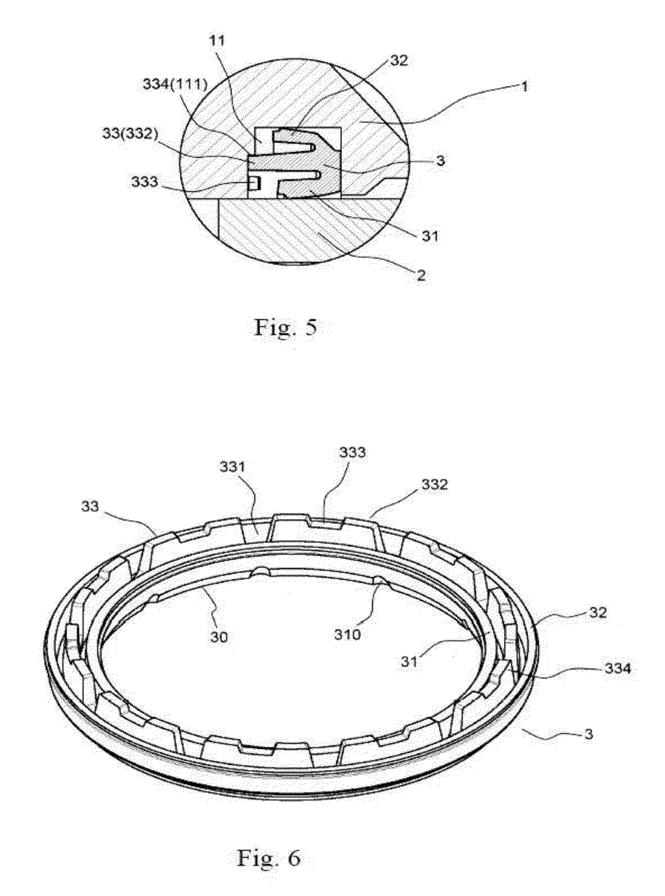

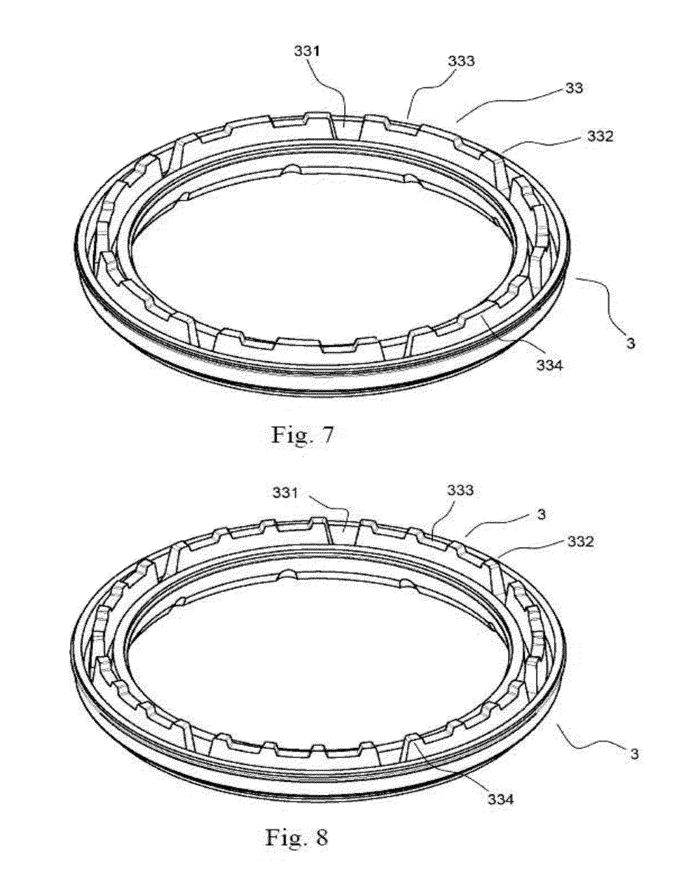

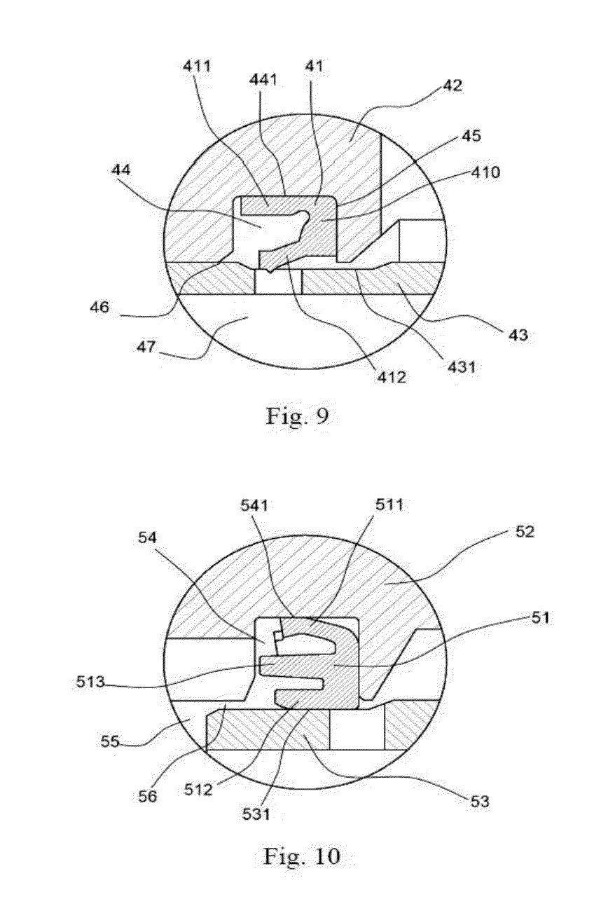

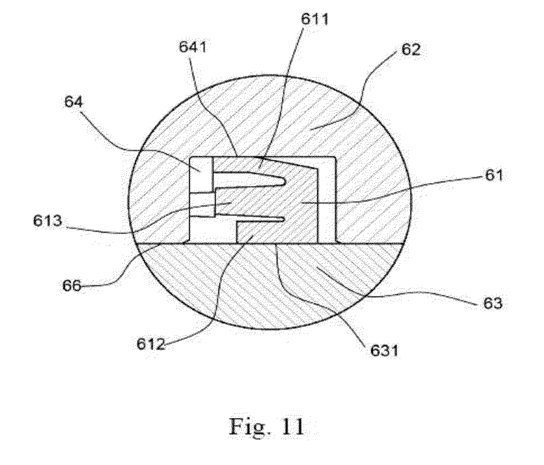

Referring to FIG. 2 and FIG. 6, a protruding circumferential middle wall 33 between the circumferential inner wall 31 and the circumferential outer wall 32, wherein the circumferential middle wall 33 extends from the base end to the free end. The circumferential middle wall 33 comprises a plurality of separated defining grooves 331 and a plurality of protruding blocks 332 respectively formed by the plurality of defining grooves 331 Each protruding block 332 comprises at least one protruding block gap 333 formed on the side toward the axis. The defining groove 331 and the protruding block gap 333 permit fluid flow along the clearance D2 between the plunger 2 and the master cylinder 1 to flow into the forth-and-back space 7 of the plunger 2. Referring to FIGS. 7-8, the plurality of protruding blocks 332 and the plurality of protruding block gaps 333 are adapted for adjusting the strength of the seal collar 3 and the flow rate of the fluid flowing through the clearance D2.

Referring to FIG. 5, in another embodiment of the present invention, the master cylinder 1 comprises a circle supporting wall 111 disposed at said holding slot 11, which is disposed on the mater cylinder 1 and adjacent the plunger 2. The circle supporting wall 111 is attached to a supporting surface 334 of the protruding block of the circumferential middle wall 33, thereby the strength of the interface between the circumferential middle wall 33 and the holding slot 11 is strengthened, the useful life of the seal collar 3 is increased.

One skilled in the art will understand that the embodiment of the present invention as shown in the drawings and described above is exemplary only and not intended to be limiting.

The embodiments of the invention have been shown and described for illustrating the functional and structural principles of the present invention and are subject to change without departure from such principles. Therefore, this invention includes all modifications encompassed within the spirit and scope of the following claims.

What is claimed is:

1. A seal collar for sealing a master cylinder and a plunger of a vehicle hydraulic-brake system, comprising a collar body, which is separated into a circumferential inner wall and a circumferential outer wall, wherein said circumferential inner wall and said circumferential outer wall are pliable;
wherein said circumferential inner wall comprises a plurality of distanced gaps disposed thereon;
wherein said circumferential inner wall and said circumferential outer wall respectively have an expansive configuration expanded outward from a base end to a free end, whereby the thickness and pitch of said circumferential inner wall and said circumferential outer wall are respectively gradually changed.

2. The seal collar, as recited in claim 1, further comprising a protruding circumferential middle wall, formed between said circumferential inner wall and said circumferential outer wall, and is extended from said base end to said free end.

3. The seal collar, as recited in claim 2, wherein said circumferential middle wall comprises a plurality of separated defining grooves and a plurality of protruding blocks respectively formed by said plurality of defining grooves.

4. The seal collar, as recited in claim 3, wherein said protruding block comprises at least one protruding block gap formed on the side toward the axis.

5. A sealed master cylinder and plunger of a vehicle hydraulic-brake system, comprising a master cylinder, a plunger and a seal collar, wherein said master cylinder is adjacent said plunger and has a holding slot disposed thereon and adjacent said plunger, and said seal collar is provided in said holding slot;
wherein said seal collar comprises a collar body, which is separated into a circumferential inner wall and a circumferential outer wall, wherein said circumferential inner wall and said circumferential outer wall are pliable;
wherein said circumferential inner wall comprises a plurality of distanced gaps disposed thereon;
wherein said circumferential inner wall and said circumferential outer wall respectively has an expansive configuration expanded outward from a base end to a free end, whereby the thickness and pitch of said circumferential inner wall and said circumferential outer wall is respectively gradual changed.

6. The sealed master cylinder and plunger, as recited in claim 5, further comprises a first fluid passage formed between said circumferential inner wall and said plunger and a second fluid passage formed between said circumferential outer wall and said holding slot.

7. The sealed master cylinder and plunger, as recited in claim 5, further comprising a protruding circumferential middle wall, which is formed between said circumferential inner wall and said circumferential outer wall, and is extended from said base end to said free end.

8. The sealed master cylinder and plunger, as recited in claim 7, wherein said circumferential middle wall comprises a plurality of separated defining grooves and a plurality of protruding blocks respectively formed by said plurality of defining grooves.

9. The sealed master cylinder and plunger, as recited in claim 8, wherein said protruding block comprises at least one protruding block gap for permitting a fluid flow along a clearance between said plunger and said master cylinder and adjusting the strength of said seal collar;
wherein said protruding block gap is formed on the side toward the axis.

10. The sealed master cylinder and plunger, as recited in claim 5, wherein said master cylinder comprises a circle supporting wall disposed at said holding slot, which is disposed on said master cylinder and adjacent said plunger.
